(19) United States
(12) Patent Application Publication
(10) Pub. No.: US 2019/0116775 A1
(43) Pub. Date: Apr. 25, 2019

(54) FISHING ACCESSORY

(71) Applicant: Stephen Andrew Leigh, Johannesburg (ZA)

(72) Inventor: Stephen Andrew Leigh, Johannesburg (ZA)

(21) Appl. No.: 16/230,000

(22) Filed: Dec. 21, 2018

Related U.S. Application Data
(63) Continuation of application No. 14/889,640, filed on Nov. 6, 2015, now abandoned.

(51) Int. Cl. A01K 91/04; A01K 85/00; A01K 91/03

(52) U.S. Cl. CPC A01K 91/04; A01K 91/03; A01K 85/00

(57) ABSTRACT

According to the invention there is provided a fishing accessory which includes a first retaining formation, a second retaining formation and a linking formation for Interlinking the first and second retaining formations so that they are offset in different planes relative to each other.

This application is a continuation of U.S. Ser. No. 14/889,640 filed Nov. 6, 2015, which is a 371 National Stage filing of PCT/ZA2014/00025, filed May 6, 2014, the disclosures of which are herein incorporated by reference.

### TECHNICAL FIELD OF THE INVENTION

This invention relates to accessories used in attaching fishhooks, lures and fishing line in various arrangements.

### BACKGROUND TO THE INVENTION

The inventor is aware of cross-lock and coast-lock snaps used in arrangements of fishhooks, fishing lines, sinkers, lures or similar fishing paraphernalia. Fishing snaps currently available in the art have all features arranged in a single plane. Traditionally, this problem may be overcome by making use of a swivel in order to allow free rotation of connected items attached to a line, lure or sinker.

A common practice is to attach treble hooks to trolling lures, through the use of a split ring. However, when a single hook is attached to a lure in a similar fashion it results in disorientation of the hook relative to the lure. In order to orient the hook an additional split ring may be inserted to correct the aspect of a single hook relative to the fishing lure. The use of multiple split rings may however lead to tangled lines and interfere with the swimming action of various lures.

It is an object of the invention to provide an alternative to existing fishhook and lure arrangements in order to overcome at least some of the difficulties identified above.

### SUMMARY OF INVENTION

According to the invention there is provided a fishing accessory which includes: a pair of retaining formations of similar shape and size for retaining articles therein; a linking formation for interlinking the pair of retaining formations in a substantial orthogonal relationship relative one another; and a pair of access arrangements for controlling the access of articles to the pair of retaining formations, the pair of access arrangements further being defined at free end regions of the retaining formations;

each of the pair of access arrangements being displaceable between an open condition for allowing access of articles to the retaining formations, and a closed condition hooking onto the linking formation for inhibiting releasing of articles from the retaining formations, respectively;
wherein the pair of access arrangements is configured to overlap one another when in the closed condition.

In one form of the invention the first and second retaining formation may be C-shaped in form.

In another form of the invention the first and second retaining formation may be in the form of a spiral.

In a further form of the invention The first and second retaining formation may be in the form of an elbow.

One application of the accessory is to attach fishhooks to fishing lures. The accessory is connected to a u-bolt of a lure by means of the first retaining formation retaining the u-bolt, with the second retaining formation retaining the fishhook. It is to be appreciated that the out of plane orientation of the retaining formations relative each other provides for a preferred alignment of the hook relative to the lure.

### BRIEF DESCRIPTION OF THE DRAWINGS

The invention will now be described by way of a non-limiting example with reference to the accompanying drawings.

In the drawings:

FIG. 1 shows a perspective view of a first embodiment of the fishing accessory; and

FIG. 2 shows a partial perspective view of a second embodiment of the fishing accessory, illustrating one of the pair of retaining formations, in accordance with the invention.

### DETAILED DESCRIPTION OF THE INVENTION

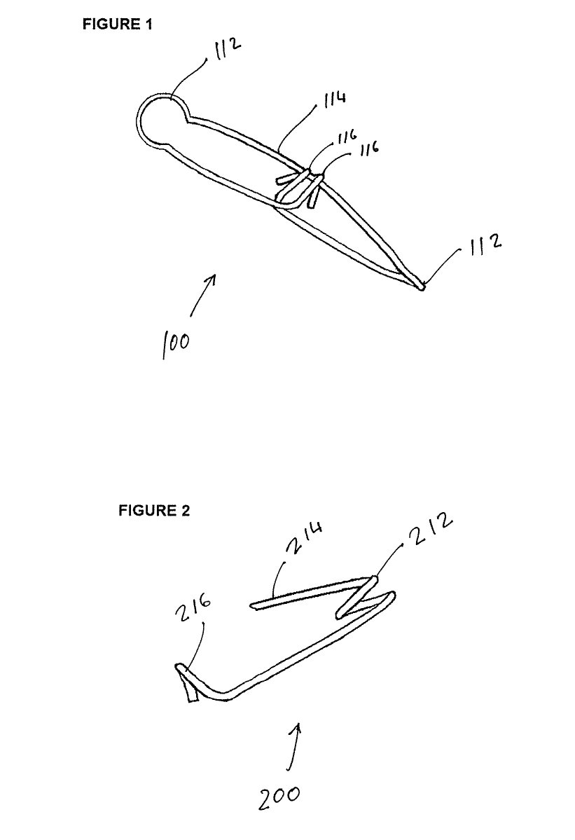

Turning now to the figures, FIG. 1 being a first embodiment of the invention shows a fishing accessory 100 which includes a pair of retaining formations 112 of similar C shape form and size for retaining articles therein, a linking formation 114 for interlinking each of the pair of retaining formations 112 in a substantial orthogonal relationship relative one another; and a pair of access arrangements 116 for controlling the access of articles to the pair of retaining formations 112, the pair of access arrangements 116 being defined at free end regions of each of the retaining formations 112, each of the pair of access arrangements being displaceable between an open condition for allowing access of articles to the retaining formations, and a closed condition hooking onto the linking formation 114 for inhibiting releasing of articles from the retaining formations 112, respectively; wherein the pair of access arrangements 116 is configured to overlap one another when in the closed condition.

In another embodiment of the invention shown in FIG. 2 each of the similar shaped and dimensioned retaining formations 212 can be in the form of a spiral with linking formation 214 interlinking the depicted retaining formation 212 and the second retaining formation (not shown.) In use, access arrangement 216 will be hooked onto linking formation 214 thereby retaining an article therein.

The Applicant considers the invention advantageous in that a fishing accessory 100 and 200 is provided which allows a user to interconnect a fishing hook to fishing lure wherein the offset arrangement of the pair retaining formations relative one another results in a higher strike rate when fishing, without the need to incorporate additional split rings, as is the conventional manner of solving the disorientated aspect of a single hook relative to a lure.

It shall be understood that the examples are provided for illustrating the invention further and to assist a person skilled in the art with understanding the invention and are not meant to be construed as unduly limiting the reasonable scope of the invention.

1. A fishing accessory which includes:
a pair of retaining formations of similar shape and size for retaining articles therein;
a linking formation for interlinking the pair of retaining formations in a substantial orthogonal relationship relative one another; and
a pair of access arrangements for controlling the access of articles to the pair of retaining formations, the pair of access arrangements further being defined at free end regions of the retaining formations;
each of the pair of access arrangements being displaceable between an open condition for allowing access of articles to the retaining formations, and a closed condition hooking onto the linking formation for inhibiting the releasing of articles from the retaining formations, respectively;
wherein the pair of access arrangements are configured to overlap one another when in the closed condition.

2-20. (canceled)

21. A fishing accessory as claimed in claim 1 wherein each of the pair of retaining formations is generally C-shaped.

22. A fishing accessory as claimed in claim 1 wherein each of the pair of retaining formations is of substantial spiral form.

23. A fishing accessory as claimed in claim 1 wherein each of the pair of retaining formations is in the form of an elbow.
